(19) United States
(12) Patent Application Publication
(10) Pub. No.: US 2021/0124818 A1
(43) Pub. Date: Apr. 29, 2021

(54) HARDWARE-BASED THROTTLING OF USER ACCESS

(71) Applicant: QUALCOMM Incorporated, San Diego, CA (US)

(72) Inventors: Baranidharan MUTHUKUMARAN, San Diego, CA (US); Satish ANAND, San Diego, CA (US); Mahadevamurty NEMANI, San Diego, CA (US); Ivan MCLEAN, San Diego, CA (US); Miguel BALLESTEROS, San Diego, CA (US)

(21) Appl. No.: 16/661,856

(22) Filed: Oct. 23, 2019

(51) Int. Cl. G06F 21/45; H04L 9/08; H04L 9/14

(52) U.S. Cl. CPC G06F 21/45; H04L 9/0894; G06F 7/588; H04L 9/14; H04L 9/0866

(57) ABSTRACT

In illustrative examples described herein, a hardware-based mechanism is provided to prevent brute force attacks on user credentials. In some examples, a throttling policy is added to a hardware key manager to provide timer-based throttling using a secure hardware timer. A register or slot in hardware is used to maintain throttling policy attributes or parameters for tracking a throttle count and a timeout value to be enforced. During a cryptographic wrap operation, a user key is associated with, or bound to, the slot or register. During a subsequent unwrap operation, the hardware key manager then enforces any needed timeouts by throttling user access in response to any incorrect entries based on the throttling policy attributes or parameters maintained in the slot or register. Examples exploiting an always-on battery-backed processing island are also provided. In some examples, throttling is implemented without the use of any secure storage.

### BACKGROUND

### Field of the Disclosure

Various features relate to user devices such as smartphones and to security procedures for use in securing such devices against unauthorized access.

### Description of Related Art

User devices such as smartphones and the confidential data stored therein may be secured against unauthorized access using access keys that are cryptographically bound to a credential known to the user. Knowledge of the credential is often the differentiating factor between the user and an attacker. Timer-based throttling of access to the device may be triggered when an incorrect credential is entered in an effort to prevent attempts by an attacker to access the device.

### SUMMARY

In one aspect, a method is provided that is operational in a processor for processing an access request where the method includes: storing a cryptographic key that is bound to an access credential; obtaining an access request including an input credential; determining whether there is a credential reentry throttling policy bound to the cryptographic key; enforcing the credential reentry throttling policy for reentry of the input credential in response to a determination that the input credential is invalid and there is a credential reentry throttling policy bound to the cryptographic key; and enabling non-throttled reentry of the access credential in response to a determination that the input credential is invalid but there is no credential reentry throttling policy bound to the cryptographic key.

In another aspect, a device for processing an access request includes: a storage element; and a processor configured to store a cryptographic key in the storage element, the cryptographic key bound to an access credential; obtain an access request including an input credential; determine whether there is a credential reentry throttling policy bound to the cryptographic key; enforce the credential reentry throttling policy for reentry of the input credential in response to a determination that the input credential is invalid and there is a credential reentry throttling policy bound to the cryptographic key; and enable non-throttled reentry of the access credential in response to a determination that the input credential is invalid but there is no credential reentry throttling policy bound to the cryptographic key.

In yet another aspect, an apparatus for processing an access request includes: means for storing a cryptographic key that is bound to an access credential; means for obtaining an access request including an input credential; means for determining whether there is a credential reentry throttling policy bound to the cryptographic key; means for enforcing the credential reentry throttling policy for reentry of the input credential in response to a determination that the input credential is invalid and there is a credential reentry throttling policy bound to the cryptographic key; and means for enabling non-throttled reentry of the access credential in response to a determination that the input credential is invalid but there is no credential reentry throttling policy bound to the cryptographic key.

In still yet another aspect, a processor-readable storage medium is provided that has one or more instructions for processing an access request which when executed by at least one processing circuit causes the at least one processing circuit to: store a cryptographic key that is bound to an access credential; obtain an access request including an invalid credential; determine whether there is a credential reentry throttling policy bound to the cryptographic key; enforce the credential reentry throttling policy for reentry of the access credential in response to a determination that the input credential is invalid and there is a credential reentry throttling policy bound to the cryptographic key; and enable non-throttled reentry of the access credential in response to a determination that the input credential is invalid but there is no credential reentry throttling policy bound to the cryptographic key.

### BRIEF DESCRIPTION OF THE DRAWINGS

FIG. 1 illustrates an exemplary processing device equipped with device hardware that includes a hardware-based key manager configured to implement timer-based user access throttling policies with no software intervention.

FIG. 2 illustrates exemplary slots or registers for storing throttling policy attributes or parameters corresponding to user root keys.

FIG. 3 illustrates an exemplary procedure for user credential enrollment and key generation.

FIG. 4 illustrates the linking of a user credential to a key.nonce to a slot.nonce stored within a register or slot.

FIG. 5 illustrates an exemplary slot access procedure.

FIG. 6 illustrates an exemplary credential verification procedure.

FIG. 7 is a timing diagram summarizing exemplary procedures that may be exploited using processor systems equipped with hardware-based throttling components.

FIG. 8 illustrates an exemplary System-on-a-Chip (SoC) that includes a hardware-based throttling controller.

FIG. 9 is a block diagram illustrating an apparatus employing a processing system that may exploit the systems, methods and apparatus described herein.

FIG. 10 is a high level block diagram illustrating exemplary components of a processing system configured to selectively enforce throttling procedures.

FIG. 11 is another block diagram that further illustrates exemplary components of a processing system configured to selectively enforce throttling procedures.

FIG. 12 is a high level flow diagram summarizing exemplary procedures for selectively enforcing throttling policies.

FIG. 13 is a flow diagram that summarizes exemplary procedures for obtaining an initial set of keys.

FIG. 14 is a flow diagram that summarizes exemplary procedures for verifying an input credential.

FIG. 15 is a flow diagram that summarizes exemplary enrollment procedures.

FIG. 16 is a flow diagram that summarizes exemplary verification procedures.

FIG. 17 is a flow diagram that summarizes further exemplary verification procedures.

FIG. 18 is a flow diagram that summarizes still further exemplary verification procedures.

FIG. 19 is a flow diagram that summarizes exemplary unwrapping procedures.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation.

### Overview

Several novel features pertain to devices and methods for use with user devices such as wireless communication devices or other computing devices. As noted above, user devices such as smartphones (or other types of user equipment (UE)) and the confidential data stored therein may be secured against unauthorized access using access keys that are cryptographically bound to a credential known to the user. Knowledge of the credential is intended to distinguish the user from an attacker. Although biometrics can provide users with a seamless mechanism for unlocking their device, biometrics may not provide a knowledge-based credential sufficient to adequately protect user data. As noted above, timer-based throttling of access to the device may be triggered when an incorrect credential is entered in an effort to prevent attempts by an attacker to access the device. That is, secure access systems may employ a throttling policy based on an access failure count. Upon each access failure (due to entry of the incorrect credential), an exponential back-off timer value is computed based on the failure count and a secure timer delays a next access attempt by the user (who might be an attacker). The current value of the failure count is stored or otherwise persisted in secure storage (with replay protection).

However, in many scenarios, implementing secure storage for storing the failure count is either not reliable or too expensive. Moreover, if timer-based enforcement of the throttling policy is implemented in software, any compromise to the secure software/firmware, could defeat the policy and compromise user data. That, is, even if timer-based throttling is enforced by secure software, a vulnerability in the software could compromise the device. With a relatively large attack surface, the chances of an attacker exploiting a vulnerability such as a software bug in secure environments may be high. Moreover, insiders who have the ability to sign the secure environment firmware/software image could override throttling. Some mitigations to these problems may involve or require access to secure storage, which, as noted, can be expensive.

Generally speaking, the security of user/enterprise data is only as strong as the software running in the secure environment or the secure storage used. Secure execution environments that enforce user credential throttling may use either internal storage e.g. secure elements) or an internal fuse-based mechanism or replay-protected memory block (RPMB) for brute force attack protection. Secure elements can provide high reliability and security but may come with significant costs. Secure processors that rely on fuses for replay protection provide high security with reasonable cost but may have reliability concerns. Also, secure processors typically can only be used with non-removable batteries. Fuse depletion is a concern when insider attack mitigation is enabled. The use of a trusted execution environment (TEE)/RPMB provides generally high reliability with low cost, but security depends on each particular implementation and issues can arise with open debug ports, lack of secure boot, etc.

In examples described herein, a hardware-based mechanism is instead provided to prevent brute force attacks on user credentials. Briefly, in illustrative examples, a key manager is used to protect keys in hardware. A particular credential reentry timer-based throttling policy is added to the key manager to provide for timer-based throttling of user entry of credentials using a secure timer. A special slot in hardware is used to track of the throttle count and the timeout to be enforced. The slot may be, for example, a dedicated hardware register. During a wrap operation (that provides encryption along with message authentication code (MAC)-processing), a key is associated with a particular slot. During the subsequent unwrap operation (which occurs during a credential verification procedure), hardware enforces timeouts based on the timer policy parameters in the slot linked to the key.

Within the hardware-based throttling mechanism, the length of timeouts may be configurable. In an example where a two minute maximum timeout per retry is enforced, a brute force attack of a 6-digit pin may take over three years (even in circumstances where secure software/firmware/storage is completely compromised in the device), as compared to perhaps only 22 hours without the hardware-based mechanism.

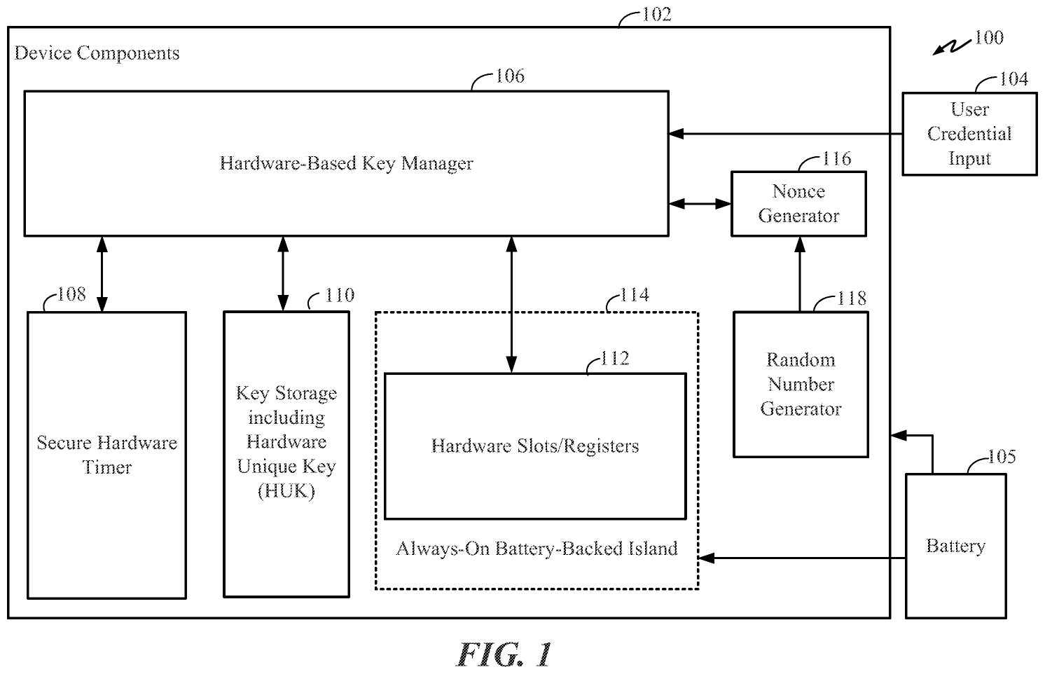

FIG. 1 summarizes hardware-based components for throttling user access to secure devices or secure data based on throttling policies linked to or associated with user access keys. A device 100, which may represent a component of a smart phone or other user device, includes device components 102 (such as the hardware components within a System-on-a-Chip (SoC)), a user credential input component 104 (such as a keypad), and a battery 105 or other power source. Among device components 102, a hardware-based key manager 106 is provided and configured to implement timer-based user access throttling policies with no software intervention. To this end, the hardware key manager 106 works in conjunction with a secure hardware timer 108, a key storage component 110 that may store, for example, a hardware unique key (HUK) and other keys, and one or more hardware slots or registers for storing or maintaining throttling policy parameters or attributes (such as a current failure count) that are bound to, or associated with, particular user keys.

As shown in FIG. 1, the hardware slots/registers 112 are configured within a portion of an always-on battery-backed island 114 connected to the battery 105. An always-on island is not necessary for the purposes of security but can provide user convenience in circumstances where the overall device is powered down and rebooted. With the slots/registers 112 configured in the battery-backed island 114, power is not lost to the slots/registers 112 even if the overall device 100 is powered down. Rather, information is lost, if at all, only if the battery 105 is completely depleted, which is rare. (Even in such cases, the device 100 may be equipped with components, not shown, for retaining information within the slots/registers 112 even after the battery 105 is fully depleted, such as by using a separate capacitor that retains some amount of charge after full battery depletion or by exploiting the remanence characteristics of certain types of circuitry.) Note, also, that the entire set of hardware slots need not be implemented within a battery-backed island. Rather, if a battery-backed island is provided, separate smaller storage registers (not shown in FIG. 1) may be provided within the island, with only minimal information stored therein such as the current failure count. During a first boot after power loss, data saved within those registers is then transferred into the hardware slots 112.

In use, a user credential, such as a user password, is input by the user via input component 104 and the key manager 106 attempts to verify the credentials using procedures described below. If the credential is not verified (for example, the entered password is incorrect), the key manager 106 triggers timer-based throttling of a next access to the device by using the hardware timer 108, with the timer value set based on parameters or other attributes obtained from a hardware slot/register 112 that stores the particular throttling policy parameters for the corresponding user key. As explained below, these procedures may exploit the use of a nonce that is stored along with the throttling policy parameters in a corresponding hardware slot/register 112. The nonce itself may be generated by a nonce generator 116 based on a random number generated by a random number generator 118.

Once the current timer value lapses, the user may reenter the credentials and, if verification fails yet again, the duration of the timer is increased in accordance with the throttling policy parameters. For example, the duration of the timer may increase exponentially, optionally up to a maximum time. Assuming the user eventually inputs the correct credential, access to the device or to secure data within the device is granted.

Notably, the implementation and control of the throttling policies is performed entirely in hardware in this example without any software intervention so that compromised software does not compromise the throttling policy. Also, as configured, attempts by an attacker to reset the throttling count back to zero by, for example, powering off and rebooting the device, are mitigated since the throttling policy parameters are maintained within hardware slots/registers 112, which are not reset (if at all) unless the battery 105 is completely depleted. Procedures are described below for properly resetting the throttling policy parameters to maximum values following a complete power loss.

Further with regard to the battery-backed island 114, the throttling policies described herein may provide strong timer-based throttling completely in hardware. However, when a device reboots, the failure count from the previous boot cannot be retrieved if the data is lost in the reboot. Accordingly, a maximum timeout may be forced on a user, which can be undesirable from the user perspective. The nonce and failure count combination is thus backed by the always-on island (persisted as long as some power is present). Since registers in the island are persisted until the battery 105 completely drains, a normal reboot does not trigger throttling. Users typically recharge their device before the battery 105 completely drains (and residual battery charge may be present up to fourteen days after device shuts down). Note also that fuses or the like are not required in the examples described herein. Moreover, no action is needed by the original equipment manufacturer (OEM) of the overall device to implement the policies described herein.

As already noted, in the case of complete battery drain or user removal of battery, a maximum timeout value is enforced. During a first boot, the key manager 106 checks the battery-backed island 114 and if data therein is invalid, the key manager 106 sets the timeout value on all of the slots 112 to a maximum value. Otherwise, the key manager 106 updates slots 112 as needed. This helps ensure that any timer policy-backed key can only be used after the maximum timeout value has been reached. Note, also, the battery-backed island 114 is not needed from a security standpoint. In some devices, an always-on battery-backed island might not be enabled on all chipsets due to costs. When feasible, the battery-backed island 114 is used and the maximum timeout value may be set, e.g., at 2-10 mins (which may be a configurable parameter). A brute force attack to a 6-digit pin may take, e.g., three to nineteen years when imposing maximum timeout values.

Insofar as the hardware timer is 108 concerned, the timer key policies described herein may depend on the security of the timer 108 that is used to enforce the timeout. In some devices, the frequency of timer 108 can be modified by software, which might be used by an attacker to defeat the purpose of the timer-based throttling. In such devices, it would be useful to modify the software to eliminate the capability to modify the frequency of the timer 108. Alternatively, other suitable mitigations may be used.

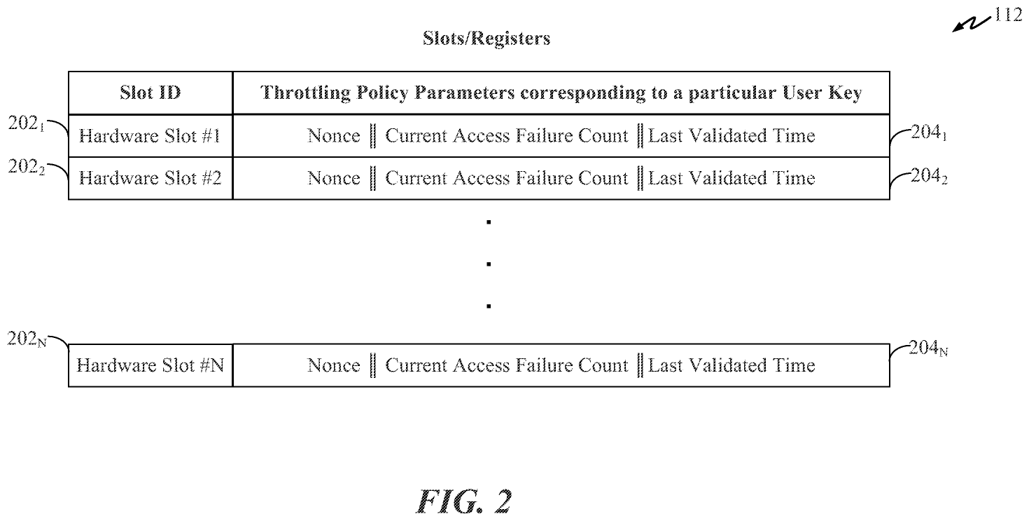

FIG. 2 illustrates an exemplary set of hardware slots or registers 112 of FIG. 1 configured for storing the aforementioned nonces and various throttling policy parameters or attributes corresponding to particular user key. As shown, each slot has a slot ID 202_{1-N} along with a parameter or attribute storage portion 204_{1-N}, which stores the corresponding nonce, a current access failure count, and the last validated time value. As shown, the values may be concatenated together for storage as a string of bits. The current access failure count may be an integer value incremented each time the user enters an incorrect credential. The last validated time is a timestamp value set to indicate the last time the user entered a valid credential. As described below, this information is used to control timer-based throttling of user access and represents a throttling policy.

Although FIG. 2 illustrates certain exemplary throttling policy parameters, additional or alternative parameters might be employed within other systems or devices. For example, the throttling policy associated with one user key may specify an exponential increase in delay time, whereas the throttling policy for another user key may specify a linear increase in delay time. As can be appreciated, a wide variety of different throttling policies can be implemented and the parameters or attributes for specifying or defining those policies may be stored within the various hardware slots. Trade-offs may arise between the flexibility gained by accommodating many different possible throttling policies versus the amount of memory needed to store all of the parameters associated with policies (and the added processing complexity). It is noted that the configuration shown in FIG. 2 uses a relatively minimal amount of memory while still permitting hardware-based control of user access throttling. In some examples, only a single slot might be provided. In other examples, two slots are provided. In still other examples, as shown, N slots are provided where N is greater than two, and might be ten or more.

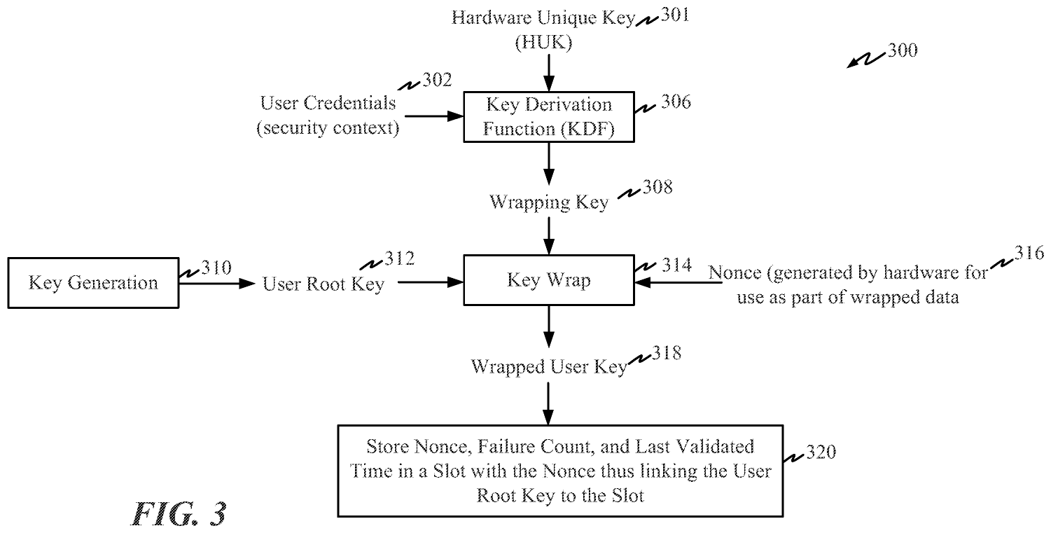

FIG. 3 is a flow diagram 300 illustrating an exemplary procedure for use by the hardware key manager 106 of FIG. 1 for enrolling user credentials and generating certain keys. A key manager reads out or otherwise obtains a HUK 301. The HUK 301 is typically stored somewhere within the hardware device itself and distinguishes the particular device from any other device. An input device inputs initial user credentials 302, such as a newly-chosen password, which are associated with a particular security context (where the security context may define, e.g., privileges and access control settings with the security environment of the device). A key derivation function or procedure 306 controlled by the key manager then generates or derives a wrapping key 308 from the user credentials 302 and the HUK 301. Meanwhile a key generation component 310 controlled by the key manager generates a user root key 312 to be associated with the user credentials 302. The key manager applies the user root key 312 and the wrapping key 308 to a key wrapping component or function 314, which also receives a nonce 316. As noted, the nonce may be generated by hardware using a random number generator. The key wrapping component 314 generates and outputs a wrapped user key 318, which is then stored at 320 for eventual use with a newly-entered user credential.

As part of the enrollment procedure 300, the key manager stores the nonce, a Failure Count, and the Last Validated Time within a hardware slot or register, with the nonce thus linking (or associating or binding) the user root key with a particular slot so the Failure Count and Last Validated Time can later be obtained for controlling throttling of access associated with that user root key. During the initial enrollment, key manager may set the Failure Count to zero and set the Last Validated Time to the current time value. Note also that the nonce stored in the slot may be referred to herein as a slot.nonce to distinguish it from other possibly different nonces associated with other user keys (e.g. key.nonces).

Any suitable key wrapping procedure, construction, or algorithm may be used in the procedure of FIG. 3 (and other procedures described herein), such as those based on Advanced Encryption Standard (AES) algorithms, e.g. AES-synthetic initialization vector (AES-SIV). Generally speaking, key wrapping constructions are a class of symmetric encryption algorithms or procedures designed to encapsulate (e.g. encrypt) cryptographic key material and are often built from standard cryptographic primitives, such as block ciphers and cryptographic hash functions. Key wraps represent a type key encapsulation algorithm but they differ from more commonly known asymmetric (public-key) key encapsulation algorithms.

In this manner, the hardware key manager derives the key wrapping key (KWK) using the user credentials as context and uses the hardware unique key as an initial root key. A “Timer key policy” is enabled for the user key during the wrap operation. The key manager generates a random nonce, which is bound to the wrap operation. Hardware or firmware (or, in some examples software) manages the slot (which stores a combination of Failure Count/Last Validated Time and the nonce) to be used. The nonce of user key is updated, the Failure Count and Last Validated Time are initialized to default values, and the wrapped user key is output (and may be sent to software).

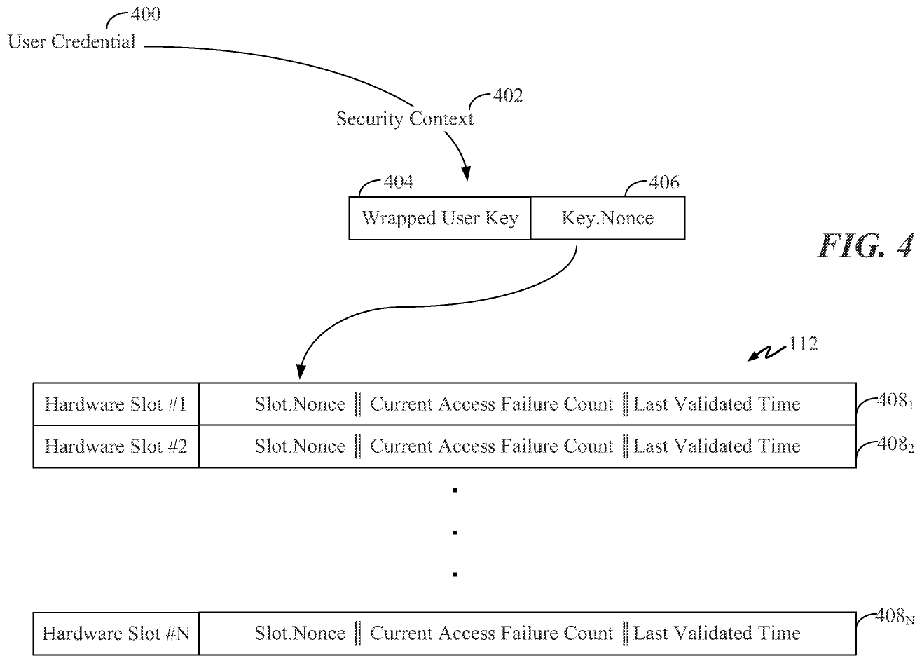

FIG. 4 schematically illustrates how a user credential is associated with wrapped user keys (and their key.nonces) and hardware slots/registers (and their slot.nonces) by using hardware slots 112 of FIGS. 1 and 2 under the control of the hardware key manager 106 of FIG. 1. Briefly, a user credential 400 is associated via a security context 402 with a corresponding wrapped user root key 404 and the nonce 406 set for that key (the key.nonce). The nonce 406 corresponds to one of the nonces (a slot.nonce) stored in a corresponding one of the hardware slots 408_{1 . . . N}. As will be explained with reference to the next figure, when a user credential is entered, the hardware key manager compares the nonce associated with the user root key (key.nonce) for that access with the various nonces stored in the slots (slot.nonces) to find a match to determine whether throttling is to be performed for the access (e.g. to determine whether throttling is required in accordance with a particular policy, or, in other cases, whether throttling is recommended, suggested, warranted, etc.)

The user credential enrollment may be summarized as follows: a user root key that is bound to timer policy is generated by, e.g. the key manager 106 of FIG. 1; a wrapping key that is bound to user credential is derived from the hardware unique key by the key manager 106 and used to wrap the user root key; and a user data encryption key is cryptographically bound to user root key to provide cryptographic binding to the user credential.

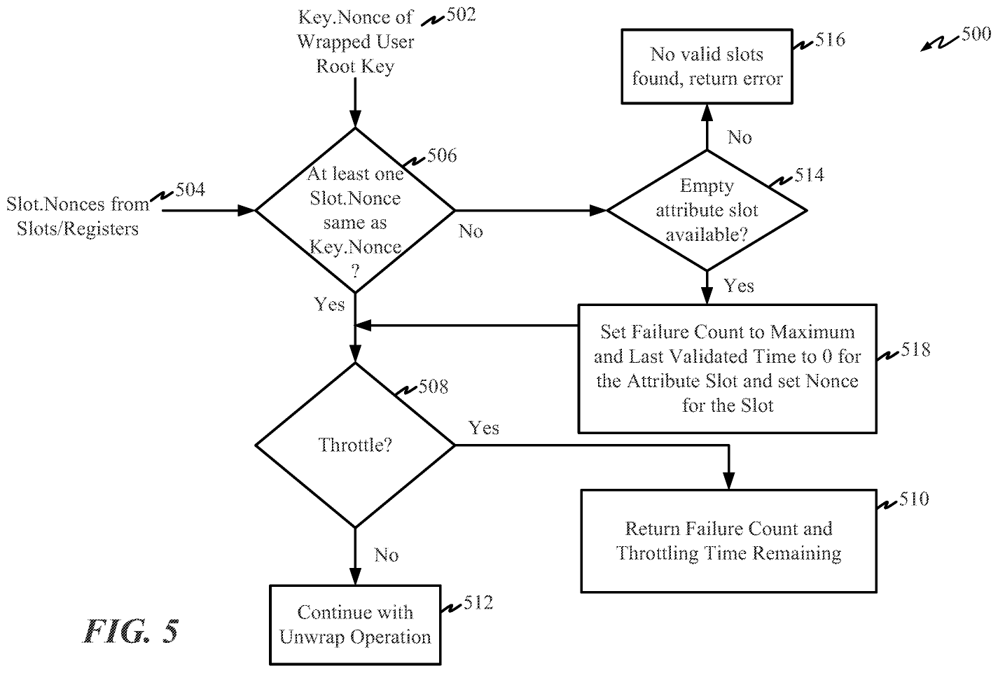

FIG. 5 illustrates an exemplary slot access procedure 500 for use, for example, by the hardware key manager 106 of FIG. 1 for accessing the slots/register 112 and determining whether throttling is enabled for a particular user root key. Upon entry of a user credential (not shown), the key manager 106 obtains a nonce 502 associated with the wrapped user key associated with the user credential (e.g. the key.nonce). (Note that the unwrapping operation has not yet been performed at this point. The key.nonce may be obtained without full unwrapping of the wrapped user root key.) Additionally, the key manager 106 obtains one or more slot.nonces 504 from the slots/registers 112. In some examples, the key.nonce 502 is compared with each of the slot.nonces at 506. Assuming that at least one of the slot.nonces 504 identically matches the key.nonce 502, the key manager 106 accesses the information stored in the matching slot/register 112 to determine, at decision block 508, whether a throttling policy is specified by that information (e.g. whether throttling is to be performed).

In other examples, a different mechanism or procedure may be used to ensure a nonce is only used in one slot. For example, the slot ID may be bound as part of the wrapping. In some implementations, this may have advantages compared to searching all slots. In any case, ensuring a particular nonce is present in only one slot is important, otherwise an attacker could reboot the device and install the same key in all the slots so the timeout will be reduce by the number of slots available.

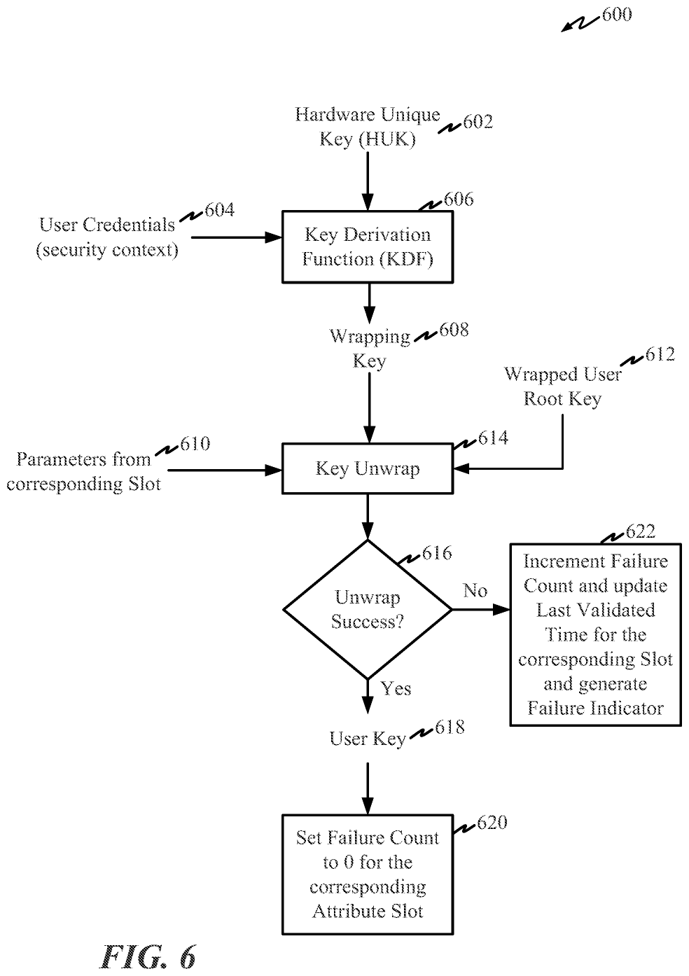

If throttling is to be performed, the key manager 106 enforces the throttling at block 510 by controlling the hardware timer 108 to throttle the next access by the current time delay value specified in the parameters or attributes stored in the slot/register 112). On the other hand, if throttling is not to be performed as determined at 508, the key manager 106 proceeds to attempt to fully unwrap the wrapped user key at block 512 (as shown in FIG. 6, described below).

Returning to decision block 506, if none of the stored slot.nonces matches the key.nonce, the key manager 106 next determines at decision block 514 whether there is an empty slot available for storing throttling information. If no free slot is available, then, at 516, the key manager 106 generates an error signal value to indicate no remaining slots available (which might then be remedied by deleting information from another slot, perhaps for a key that is no longer being used). Assuming, though, that at least one free slot is still available, the key manager 106 at block 516 sets the nonce value for the slot to the key.nonce value. The key manager 106 also sets the Failure Count to its maximum value and sets the Last Validated Time to zero for that particular slot to indicate that the slot information is new. Then, again, a determination is made at 508 by the key manager 106 as to whether throttling is needed and processing proceeds as already described.

FIG. 6 illustrates an exemplary procedure 600 for credential verification based on successful unwrapping of a previously-wrapped user root key that may be performed by the hardware key manager 106 of FIG. 1. The hardware unique key 602 is again obtained by the key manager 106 and user credentials for 604 are input by the user. (These user credentials may be referred to as candidate credentials since they have not yet been verified to be correct and may be erroneous credentials provided by a valid user or false credentials provided by a hacker as part of a brute force attack.) The same key derivation function or component 606 of the key manager 106 used during the enrollment then processes the user credential 604 and the hardware unique key 602 to generate a (candidate) wrapping key 608. Next, the key manager 106 obtains parameters or attributes 610 from the corresponding key slot (identified in FIG. 5) and obtains the previously-generated wrapped user key 612 from storage (which is the wrapped key initially generated during enrollment, as shown in FIG. 3).

A key unwrap function or component 614 of the key manager 106 then attempts to unwrap the wrapped user key 612 using the wrapping key 608 and the parameters or attributes 610 from the slot from the corresponding slot, such as the corresponding slot.nonce. Assuming the unwrap procedure of block 614 is successful, as determined at decision block 616, the user key 618 obtained from the user key unwrapping procedure 614 is thus a verified and may then be used to unlock the device (if that is the purpose of the credential 604) or used to access secured data within the device (if that is the purpose of the credential 604).

Following successful generation of the user (root) key 618, the key manager 106 then, at block 620, resets the Failure Count associated with the key to zero for storing in the corresponding slot. On the other hand, if the unwrapping procedure 614 was not successful because the user credentials 604 were not correct, then at block 622 the key manager 106 increments the corresponding Failure Count and updates the Last Validated Time (to a new Last Validated Time) and those values are stored in the corresponding slot for subsequent use. A failure indicator or signal is generated by the key manager 106 to indicate that the user credential 604 was invalid. Reentry of the user credential by the user is then delayed by the above-described hardware timer based on the current failure count (as shown in the next figure).

User credential verification may be summarized as follows: a wrapping key is derived by the hardware key manager 106 from HUK using the provided credential; if unwrap operation succeeds, the provided user credential is valid and data can be successfully decrypted; or if unwrap fails, the key manager 106 enforces the timeout policy provided during enrollment and key generation.

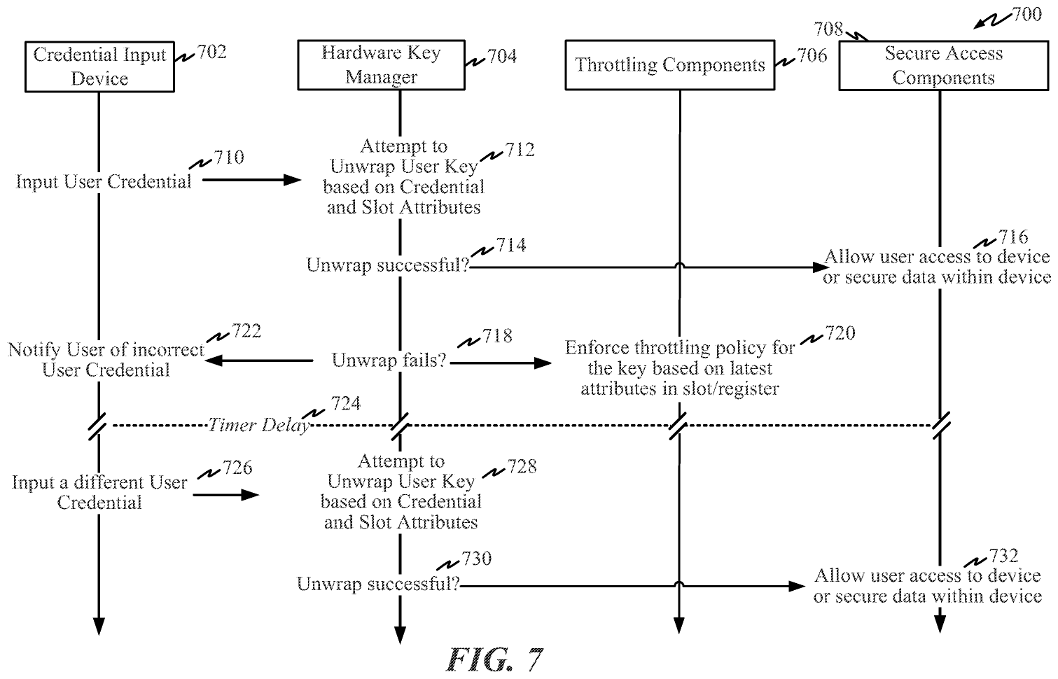

FIG. 7 summarizes some of the aforementioned features by way of an exemplary timing diagram 700, which illustrates functions or operations of the following components: a credential input device 702 (which may be the input component 104 of FIG. 1), a hardware key manager 704 (which may be the key manager 106 of FIG. 1), a throttling component 706 (which may include the timer 108 of FIG. 1), and a secure access component 708 (which may be another component of device 100 of FIG. 1). Beginning at 710, the input device 702 inputs a user credential, which is then provided to the hardware key manager 704. The key manager 704 attempts to unwrap the user root key based upon input credential and the slot attributes or parameters associated with that key, at 712. If the unwrap procedure is successful, at 714, the key manager 704 sends a signal to the secure access component 708 to allow user access at 716 to the device itself (e.g. unlocking the smartphone) or to secure data within the device. However, if the unwrap operation fails, at 718, then the throttling components 706 enforce the throttling policy at 720 for the key based on the latest attributes or parameters stored in the corresponding slot or register. Additionally, the credential input device 702 receives a signal at 722 to notify the user that the incorrect credential was entered. A timer delay time is imposed by the throttling components 706, as shown by timer delay 724. Once the timer has expired, the user may input a different user credential at 726, and another attempt is made at 728 by the key manager to unwrap the user root key based on the new credential and the corresponding slot attributes. Assuming the unwrap is now successful, at 730, the key manager sends a signal to the secure access components 708 to grant user access to secure the device or to data or components within the device, at 732. Although not shown in FIG. 7, if the unwrap procedure is again unsuccessful because an incorrect credential is again entered, then yet another time delay is imposed by the throttling components 706, often of a longer duration, before the user is permitted to reenter the credential.

The above-described procedures serve, among other features, to bind a key to a throttling policy key slot or register. The current state of a key slot should to be associated with a single key. If not, an attacker might generate a different key and use that to subvert timeout enforcement. With no access to secure storage, the key manager binds the key to the corresponding key slot that holds the Failure Count and Last Validated Time. One possible option is to use a Hash/MAC of a “key blob” and store that in the key slot. However, such an approach may consume at least sixteen bytes, which may be undesirable for many applications. Instead, the key manager is configured to generate a 64-bit nonce and to associate that nonce with both the key as well as the key slot during the key wrap operation. The nonce is part of the authenticated data (e.g. authenticated but not encrypted). A 64-bit nonce is deemed sufficient in this scenario as the nonce is uniformly random (and may be retrieved from a random number generator) and is not susceptible to a birthday attack. A brute force attack directed to the 64-bit nonce likely would take way more time than the maximum timeout that hardware will enforce and so the nonce is sufficiently secure. In some examples, the maximum timeout values are configurable at 30 seconds, 2 minutes, 5 minutes, and 10 minutes. In some examples, a failure count of 0-4 triggers no timeout delay, a failure count of 5 triggers a 30 second delay, a failure count of 6 or more triggers still longer delays. Note that a 64-bit nonce is just one example. Nonces of other sizes may be used, with the nonce size chosen, at least in part, based on the maximum timeout that is selected or desired.

Aspects of the systems and methods described herein can be exploited using a wide variety of mobile devices or other wireless user equipment (UE) devices and for a wide range of applications. To provide a concrete example, an exemplary SoC hardware environment will now be described wherein UE components are provided on a SoC processing circuit for use in a mobile communication device or other access terminal.

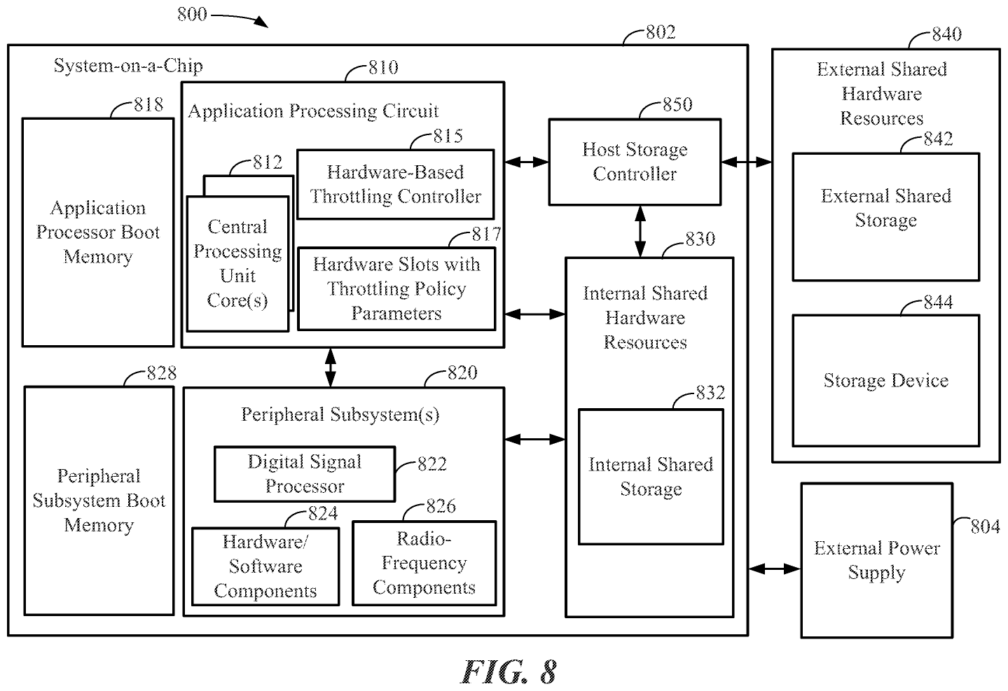

FIG. 8 illustrates selected components of a UE or other mobile device 800 having a SoC processing circuit 802 configured in accordance with one example where various novel features may be exploited (where the processing circuit 802 may include, e.g., the hardware components of FIG. 1, not all of which are shown in FIG. 8). The SoC processing circuit 802 receives power from an external power supply 804 and includes an application processing circuit 810, which includes a multi-core central processing unit (CPU) 812 and typically controls the operation of all components of the mobile communication device. Note that the external power supply is external to the SoC but is an internal component of the UE 800 and may include, e.g., a rechargeable battery. In the example of FIG. 8, the application processing circuit 810 is equipped to include (or operate in conjunction with) a hardware-based throttling controller 815. Controller 815 may be configured or equipped to perform or control the various hardware-based throttling operations discussed herein, such as controlling, the throttling of access attempts to resist guessing attacks by using throttling policy attributes or parameter stored in hardware slots or registers 817 of the SoC.

In the example of FIG. 8, the application processing circuit 810 is also coupled to a host storage controller 850 for controlling storage of data in an internal shared storage device 832 (such as static random access memory (SRAM) or flash) that forms part of internal shared hardware resources 830. The application processing circuit 810 may also be coupled to application processor boot memory 818 (such as RAM or read-only only memory (ROM)) that stores boot sequence instructions for the various components of the SoC processing circuit 802. The SoC processing circuit 802 further includes one or more peripheral subsystems 820 controlled by application processing circuit 810. The peripheral subsystems 820 may include but are not limited to a storage subsystem (e.g., ROM, RAM), a video/graphics subsystem (e.g., digital signal processing circuit (DSP), graphics processing circuit unit (GPU)), an audio subsystem (e.g., DSP, analog-to-digital converter (ADC), digital-to-analog converter (DAC)), a power management subsystem, security subsystem (e.g., encryption components and digital rights management (DRM) components), an input/output (I/O) subsystem (e.g., keyboard, touchscreen) and wired and wireless connectivity subsystems (e.g., universal serial bus (USB), Global Positioning System (GPS), Wi-Fi, Global System Mobile (GSM), Code Division Multiple Access (CDMA), 4G Long Term Evolution (LTE) modems). The exemplary peripheral subsystem 820, which is a modem subsystem, includes a DSP 822, various other hardware and software components 824, and various radio-frequency (RF) components 826. In one aspect, each peripheral subsystem 820 also includes a peripheral subsystem boot memory 828 (such as boot RAM or ROM) that stores a primary boot image (not shown) of the associated peripheral subsystems 820. As noted, the SoC processing circuit 802 further includes various internal shared hardware resources 830, such as the aforementioned internal shared storage 832 (e.g. SRAM, flash memory, etc.), which is shared by the application processing circuit 810 and the various peripheral subsystems 820 to store various runtime data or other parameters and to provide host memory and which may store various keys or passwords for secure processing.

In one aspect, the components 810, 815, 817, 818, 820, 828, 830 and 850 of the SoC 802 are integrated on a single-chip substrate. The SoC processing circuit 802 further includes various external shared hardware resources 840, which may be located on a different chip substrate and may communicate with the SoC processing circuit 802 via one or more buses. External shared hardware resources 840 may include, for example, an external shared storage 842 (e.g. double-data rate (DDR) dynamic RAM) and/or permanent or semi-permanent data storage device 844 (e.g., a secure digital (SD) card, hard disk drive (HDD), an embedded multimedia card, a universal flash device (UFS), etc.), which may be shared by the application processing circuit 810 and the various peripheral subsystems 820 to store various types of data, such as an operating system (OS) information, system files, programs, applications, user data, audio/video files, etc. When the UE incorporating the SoC processing circuit 802 is activated, the SoC processing circuit begins a system boot up process in which the application processing circuit 810 may access boot RAM or ROM 818 to retrieve boot instructions for the SoC processing circuit 802, including boot sequence instructions for the various peripheral subsystems 820. The peripheral subsystems 820 may also have additional peripheral boot RAM or ROM 828.

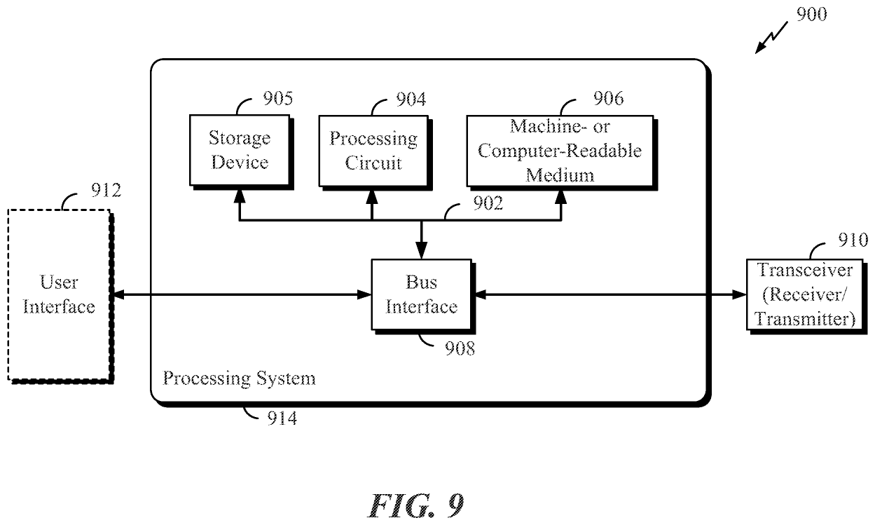

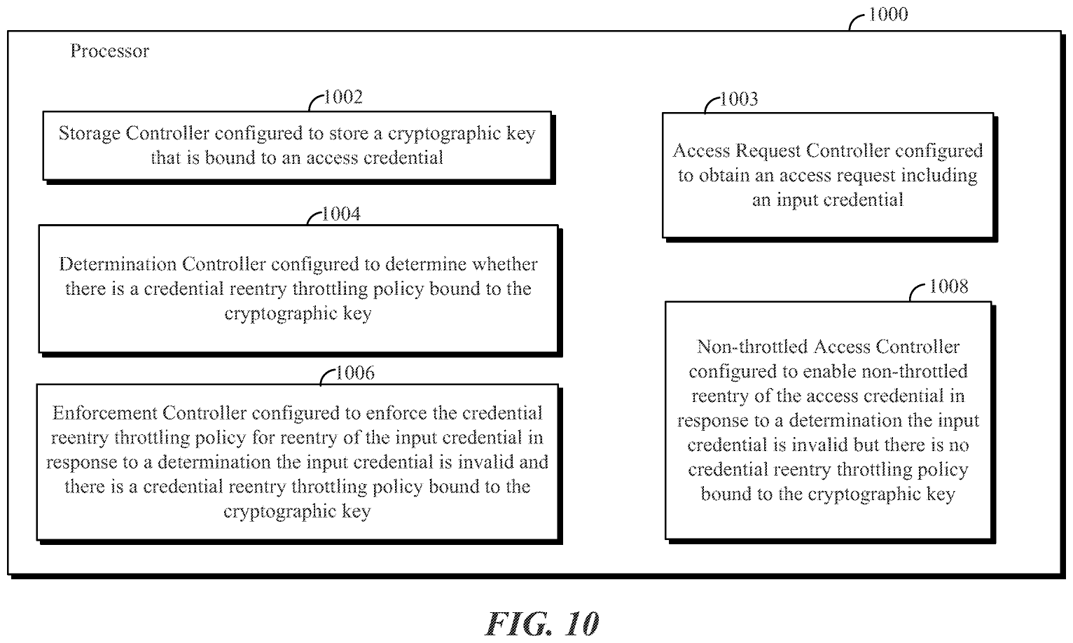

FIG. 9 illustrates an overall system or apparatus 900 in which the systems, methods and apparatus of FIGS. 1-8 may be implemented. In accordance with various aspects of the disclosure, an element, or any portion of an element, or any combination of elements may be implemented with a processing system 914 that includes one or more processing circuits 904 such as the SoC processing circuit of FIG. 8. For example, apparatus 900 may be a UE of a mobile communication system. Apparatus 900 may be used with a radio network controller (RNC). In addition to an SoC, examples of processing circuits 904 include microprocessing circuits, microcontrollers, DSPs, field programmable gate arrays (FPGAs), programmable logic devices (PLDs), state machines, gated logic, discrete hardware circuits, and other suitable hardware configured to perform the various functionality described throughout this disclosure. That is, the processing circuit 904, as utilized in the apparatus 900, may be used to implement any one or more of the processes described above and illustrated in FIGS. 1, 2, 3, 4, 5, 6, 7, 8, and 9 (and/or FIGS. 10, 11, 12, 13, 14, 15, 16, 17, 18, and 19 discussed below).

In the example of FIG. 9, the processing system 914 is implemented with a bus architecture, represented generally by the bus 902. The bus 902 may include any number of interconnecting buses and bridges depending on the specific application of the processing system 914 and the overall design constraints. The bus 902 links various circuits including one or more processing circuits (represented generally by the processing circuit 904), the storage device 905, and a machine-readable, processor-readable, processing circuit-readable or computer-readable media (represented generally by a non-transitory machine-readable medium 906) The bus 902 may also link various other circuits such as timing sources, peripherals, voltage regulators, and power management circuits, which are well known in the art, and therefore, will not be described any further. The bus interface 908 provides an interface between bus 902 and a transceiver 910, i.e. a receiver/transmitter. The transceiver 910 provides a means for communicating with various other apparatus over a transmission medium. Depending upon the nature of the apparatus, a user interface 912 (e.g., keypad, display, speaker, microphone, joystick) may also be provided.

The processing circuit 904 is responsible for managing the bus 902 and for general processing, including the execution of software stored on the machine-readable medium 906. The software, when executed by processing circuit 904, causes processing system 914 to perform the various functions described herein for any particular apparatus. Machine-readable medium 906 may also be used for storing data that is manipulated by processing circuit 904 when executing software.

One or more processing circuits 904 in the processing system may execute software or software components. Software is to be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The software may reside on machine-readable medium 906. The machine-readable medium 906 may be a non-transitory machine-readable medium or computer-readable medium. A non-transitory processing circuit-readable, machine-readable or computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer.

Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer. The terms “machine-readable medium”, “computer-readable medium”, “processing circuit-readable medium” and/or “processor-readable medium” may include, but are not limited to, non-transitory media such as portable or fixed storage devices, optical storage devices, and various other media capable of storing, containing or carrying instruction(s) and/or data.

Hence, in one aspect of the disclosure, processing circuit 904 illustrated in FIG. 9 may be a specialized processing circuit (e.g., an application specific integrated circuit (ASIC)) that is specifically designed and/or hard-wired to perform the algorithms, methods, and/or blocks described in FIGS. 1, 2, 3, 4, 5, 6, 7, 8, and 9 (and/or FIGS. 10, 11, 12, 13, 14, 15, 16, 17, 18, and 19 discussed below). Thus, such a specialized processing circuit (e.g., ASIC) may be one example of a means for executing the algorithms, methods, and/or blocks described in FIGS. 1, 2, 3, 4, 5, 6, 7, 8, and 9 (and/or FIGS. 10, 11, 12, 13, 14, 15, 16, 17, 18, and 19 discussed below). The machine-readable storage medium may store instructions which when executed by a specialized processing circuit (e.g., ASIC) causes the specialized processing circuit to perform the algorithms, methods, and/or blocks described herein.

The machine-readable medium 906 may reside in the processing system 914, external to the processing system 914, or distributed across multiple entities including the processing system 914. The machine-readable medium 906 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system. For example, the machine-readable storage medium 906 may have one or more instructions which when executed by the processing circuit 904 (formed, e.g., on an IC die) causes the processing circuit to: store a cryptographic key that is bound to an access credential; obtain an access request including an input credential; determine whether there is a credential reentry throttling policy bound to the cryptographic key; enforce the credential reentry throttling policy for reentry of the access credential in response to a determination that the input credential is invalid and there is a credential reentry throttling policy bound to the cryptographic key; and enable non-throttled reentry of the access credential in response to a determination that the input credential is invalid but there is no credential reentry throttling policy bound to the cryptographic key. As noted, in many examples described herein, these functions are instead implemented in hardware.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

The various illustrative logical blocks, modules, circuits, elements, and/or components described in connection with the examples disclosed herein may be implemented or performed with a general purpose processing circuit, a DSP, an ASIC, FPGA or other programmable logic component, discrete gate or transistor logic, discrete hardware components, or any combination thereof designed to perform the functions described herein. A general purpose processing circuit may be a microprocessing circuit, but in the alternative, the processing circuit may be any conventional processing circuit, controller, microcontroller, or state machine. A processing circuit may also be implemented as a combination of computing components, e.g., a combination of a DSP and a microprocessing circuit, a number of microprocessing circuits, one or more microprocessing circuits in conjunction with a DSP core, or any other such configuration.

FIG. 10 illustrates selected and exemplary components of a processing circuit or processor 1000 (such as the processing circuit 904 of FIG. 9 of a UE or other device) that includes: a storage controller 1002 configured to store a cryptographic key that is bound to an access credential (such as a user access credential); an access request controller 1003 configured to obtain (e.g. input or receive) an access request including an input credential; a determination controller 1004 configured to determine whether there is a credential reentry throttling policy bound to the cryptographic key; an enforcement controller 1006 configured to enforce the credential reentry throttling policy for reentry of the input credential in response to a determination the input credential is invalid and there is a credential reentry throttling policy bound to the cryptographic key; and a non-throttled access controller 1008 configured to enable non-throttled reentry of the access credential in response to a determination the input credential is invalid but there is no credential reentry throttling policy bound to the cryptographic key. The processor of FIG. 10 or its components may correspond, in some examples, to the device of FIG. 1. Detailed examples of the components of FIG. 10 and their subcomponents are described above.

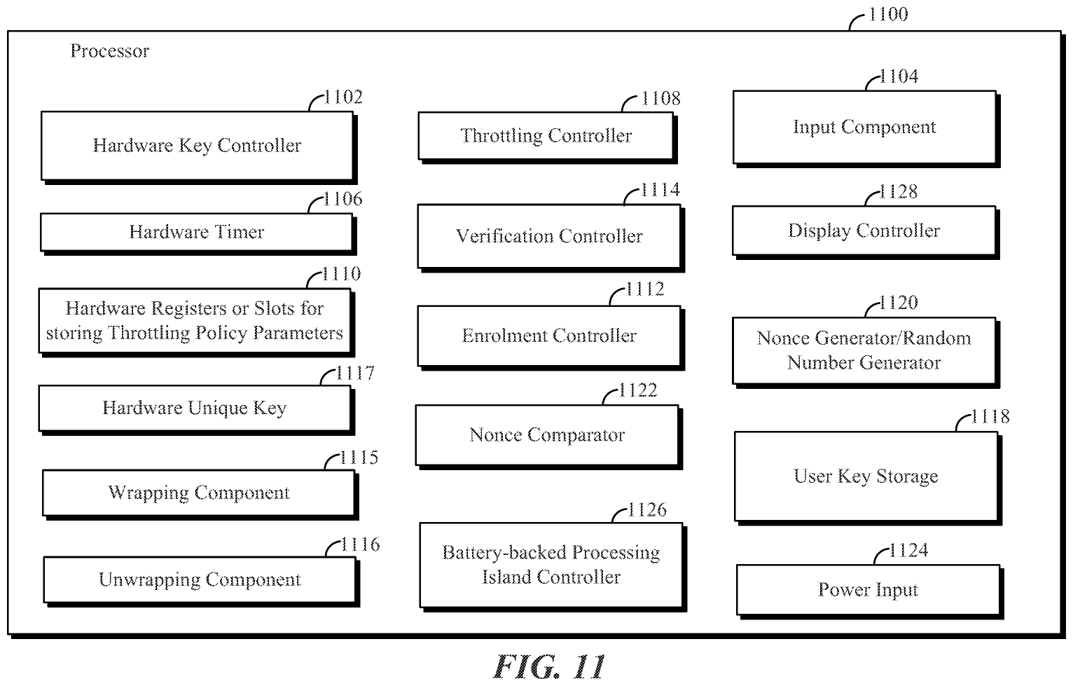

FIG. 11 illustrates selected and exemplary components of a processing circuit or processor 1100 (such as the processing circuit 904 of FIG. 9 of a UE or other device) with components equipped to perform the various functions discussed above. A hardware key controller 1102 is configured, for example, to generate or obtain various keys and to determine, in response to a credential input by an input component 1104, whether to throttle further credential input. The hardware key controller 1102 operates in conjunction with other components or devices such as a hardware timer 1106 for tracking a time delay, a throttling controller 1108 for delaying further credential processing based on timer values, and a set of hardware registers or slots 1110 for storing throttling policy parameters that affect the amount of throttling. Additional components of the processor include: an enrollment controller 1112 for controlling credential enrollment procedures; a verification controller 1114 for controlling credential verification procedures; a wrapping component 1115 for wrapping values such as keys and nonces; and an unwrapping component 1116 for unwrapping values such as keys and nonces. Still further, the processor includes: a HUK component 1117 for storing an HUK; a user key storage 1118 for storing user keys and other keys; a nonce generator/RNG 1120 for generating nonces; a nonce comparator 1122 for comparing nonces; and power input component 1124 for receiving power from a power source such as a battery; and a battery-backed processing island controller 1126 for controlling functions pertaining to a battery-backed processing island, if any, provided within the processing system 1100. A display controller 1128 controls the presentation of displays to a user, such as notifications of correct or incorrect credential input.

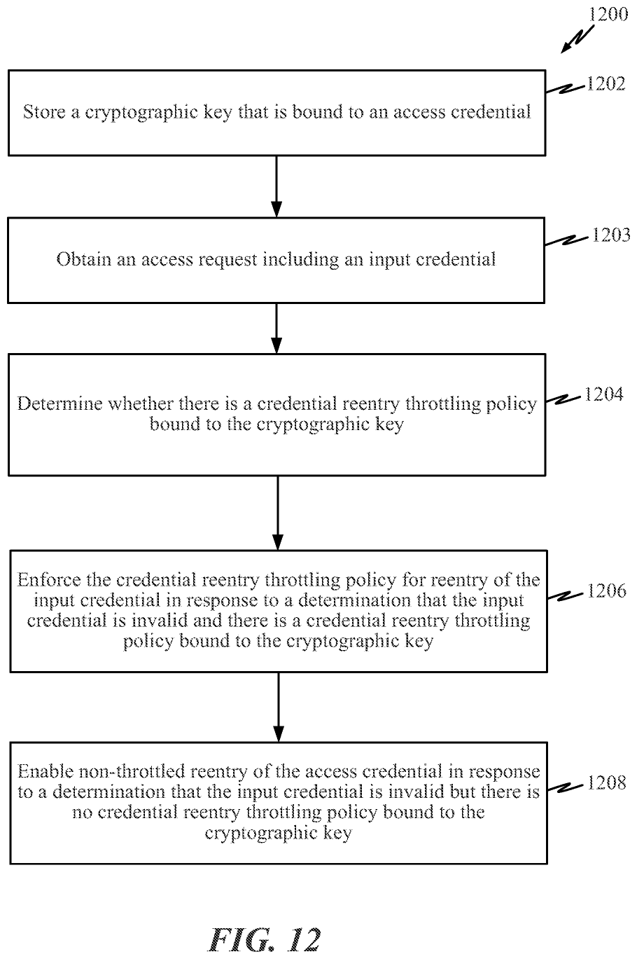

FIG. 12 broadly illustrates and summarizes exemplary methods or procedures 1200 that may be performed by suitably equipped devices or components, such as the processors of FIGS. 10 and 11. Briefly, at 1202, the processor stores a cryptographic key that is bound to an access credential (such as by storing the key within a storage register or memory element). At 1203, the processor obtains an access request including an input credential (such as by inputting or receiving an input password). At 1204, the processor determines whether there is a credential reentry throttling policy bound to the cryptographic key. At 1206, the processor enforces the credential reentry throttling policy for reentry of the input credential in response to a determination that the input credential is invalid and there is a credential reentry throttling policy bound to the cryptographic key. At 1208, the processor enables non-throttled reentry of the access credential in response to a determination that the input credential is invalid but there is no credential reentry throttling policy bound to the cryptographic key.

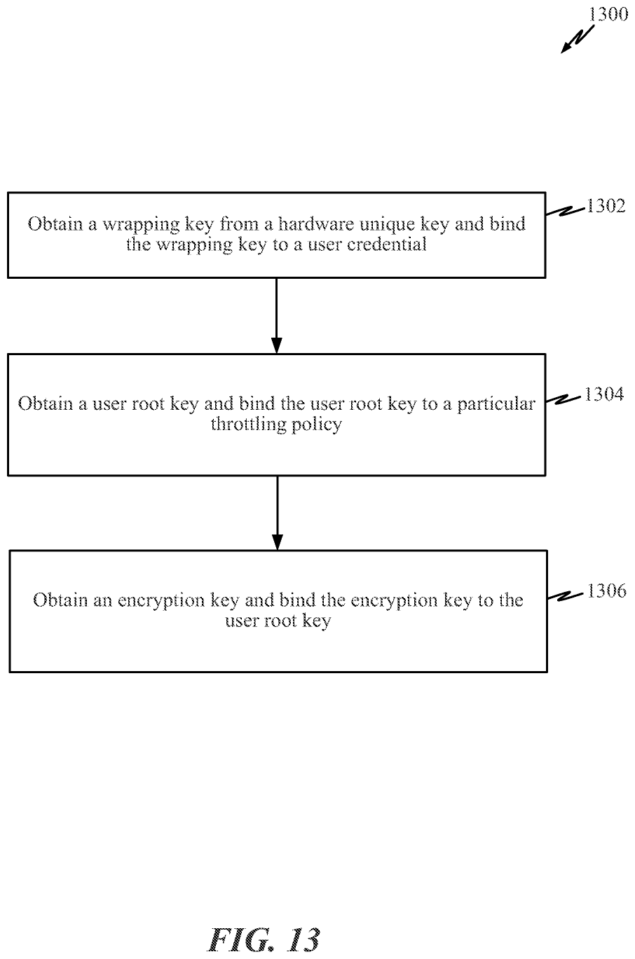

FIG. 13 broadly illustrates and summarizes other exemplary methods or procedures 1300 that may be performed by suitably equipped devices or components, such as the processors of FIGS. 10 and 11, to obtain initial keys for subsequent use, for example, in the method FIG. 12. Briefly, at 1302, the processor obtains a wrapping key from a hardware unique key and binds the wrapping key to a user credential. At 1304, the processor obtains a user root key and binds the user root key to a particular throttling policy. At 1306, the processor obtains an encryption key and binds the encryption key to the user root key.

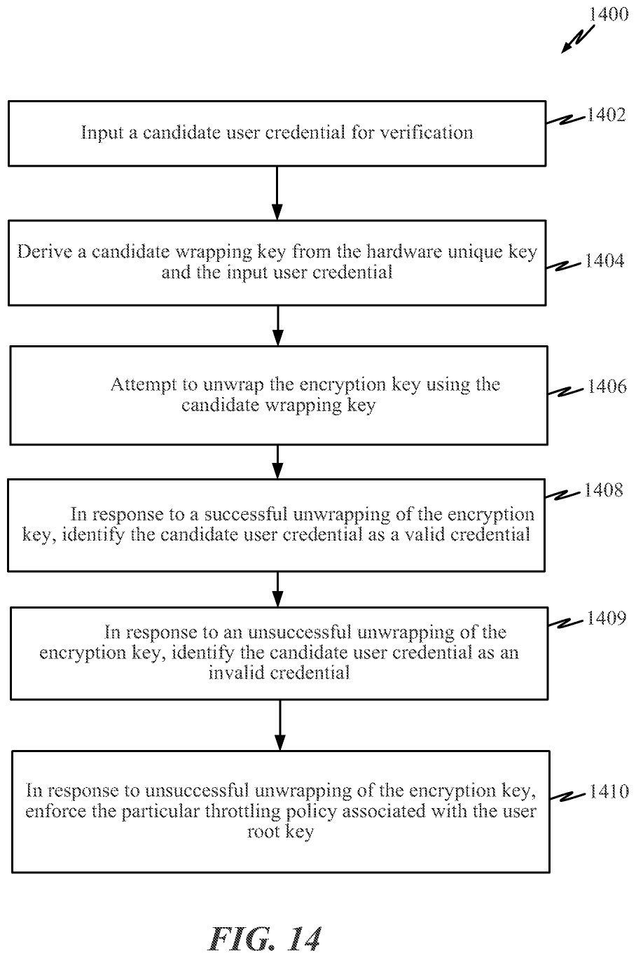

FIG. 14 broadly illustrates and summarizes other exemplary methods or procedures 1400 that may be performed by suitably equipped devices or components, such as the processors of FIGS. 10 and 11, to verify an input credential for use, for example, along with the method FIG. 12. Briefly, at 1402, the processor inputs a candidate user credential for verification. At 1404, the processor derives a candidate wrapping key from the hardware unique key and the input user credential. At 1406, the processor attempts to unwrap the encryption key using the candidate wrapping key. At 1408, the processor, in response to a successful unwrapping of the encryption key, identifies the candidate user credential as valid. At 1409, the processor, in response to an unsuccessful unwrapping of the encryption key, identifies the candidate user credential as invalid. At 1410, the processor, in response to unsuccessful unwrapping of the encryption key, enforces the particular throttling policy associated with the user root key.

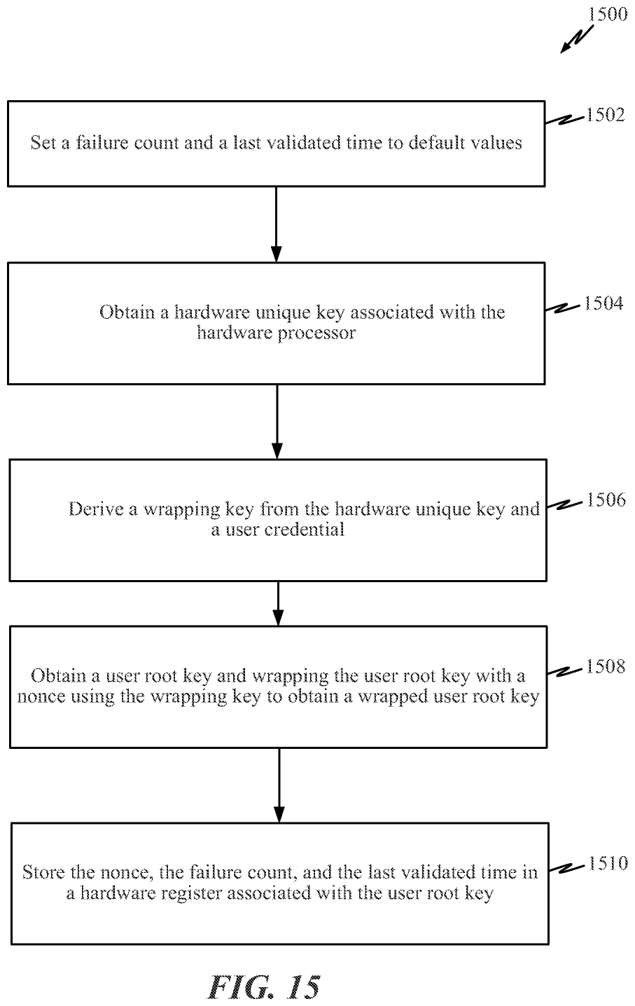

FIG. 15 broadly illustrates and summarizes other exemplary methods or procedures 1500 that may be performed by suitably equipped devices or components, such as processors of FIGS. 10 and 11, to enroll a user credential for use, for example, along with the method FIG. 12. Briefly, at 1502, the processor sets a failure count and a last validated time to respective default values. At 1504, the processor obtains a hardware unique key associated with the processor. At 1506, the processor derives a wrapping key from the hardware unique key and a user credential. At 1508, the processor obtains a user root key and wrapping the user root key with a nonce using the wrapping key to obtain a wrapped user root key. At 1510, the processor stores the nonce, the failure count, and the last validated time in a hardware register associated with the user root key.

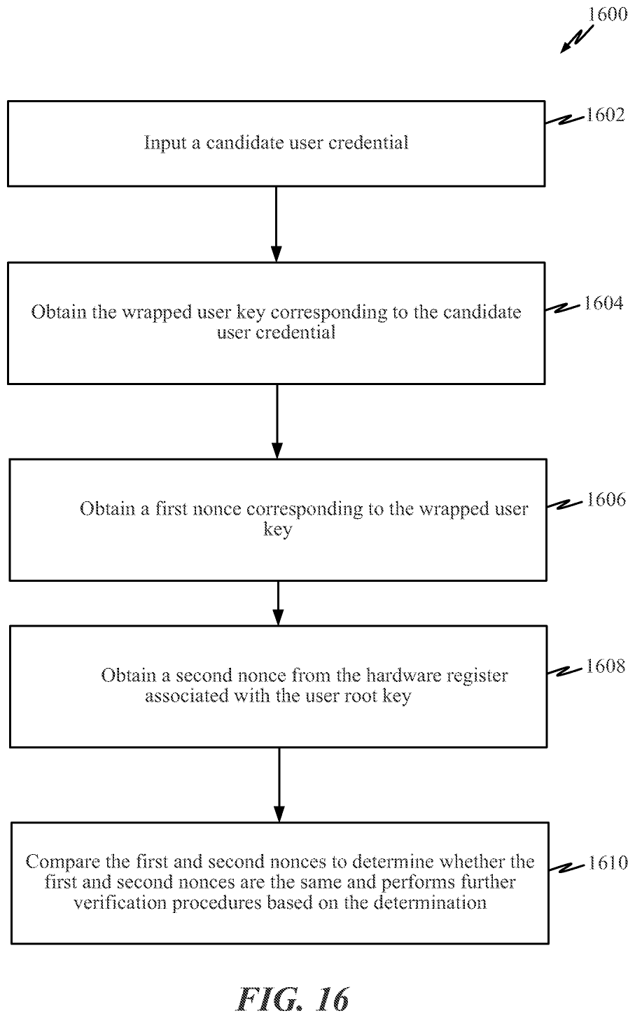

FIG. 16 broadly illustrates and summarizes other exemplary methods or procedures 1600 that may be performed by suitably equipped devices or components, such as the processors of FIGS. 10 and 11, to verify a user credential for use, for example, along with the method FIG. 15. Briefly, at 1602, the processor inputs a candidate user credential. At 1604, the processor obtains the wrapped user key corresponding to the candidate user credential. At 1606, the processor obtains a first nonce (such as a key.nonce) corresponding to the wrapped user key. At 1608, the processor obtains a second nonce (such as a slot.nonce) from the hardware register associated with the user root key. At 1608, the processor compares the first and second nonces to determine whether the first and second nonces are the same and performs further verification procedures based on the determination.

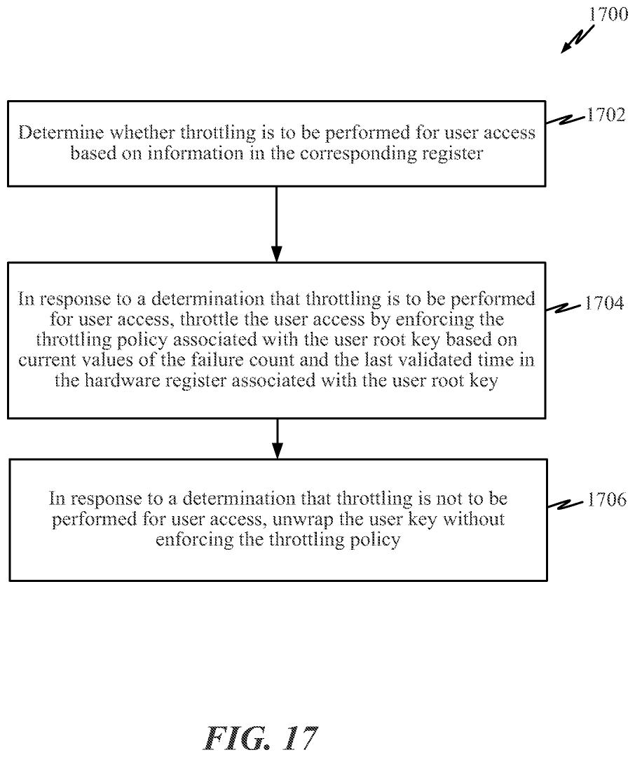

FIG. 17 broadly illustrates and summarizes other exemplary methods or procedures 1700 that may be performed by suitably equipped devices or components, such as the processors of FIGS. 10 and 11, to verify a user credential for use, for example, along with the method FIG. 16 in circumstances where the first and second nonces are the same. Briefly, at 1702, the processor determines whether throttling is to be performed for user access. At 1704, in response to a determination that throttling is to be performed for user access, the processor throttles the user access by enforcing the throttling policy associated with the user root key based on current values of the failure count and the last validated time in the hardware register associated with the user root key. At 1706, in response to a determination that throttling is not to be performed for user access, the processor unwraps the user key without enforcing the throttling policy.

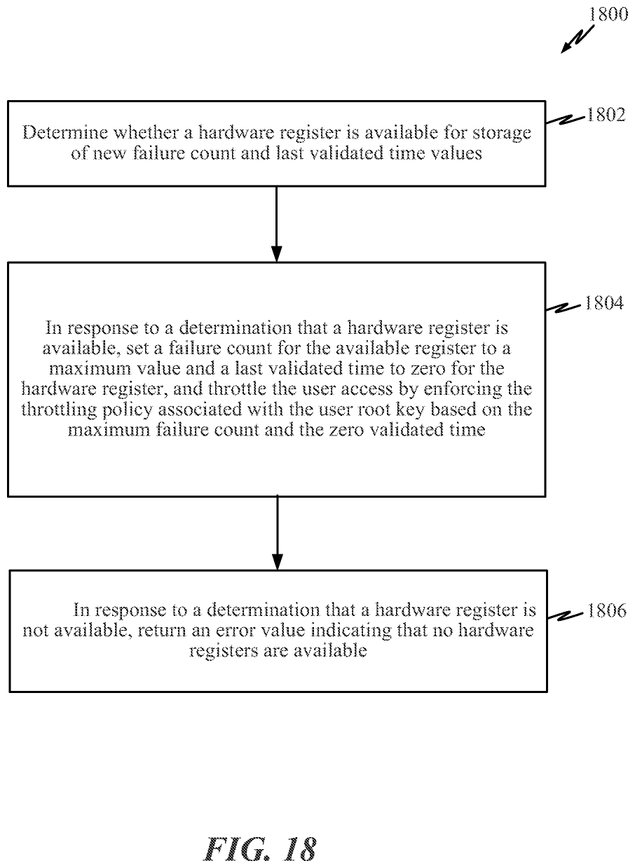

FIG. 18 broadly illustrates and summarizes other exemplary methods or procedures 1800 that may be performed by suitably equipped devices or components, such as the processors of FIGS. 10 and 11, to verify a user credential for use, for example, along with the method FIG. 16 in circumstances where the first and second nonces are not the same. Briefly, at 1802, the processor determines whether a hardware register is available for storage of new failure count value and last validated time values. At 1804, in response to a determination that a hardware register is available, the processor sets a failure count for the available register to a maximum failure count value and a last validated time to zero for the hardware register and throttles user access by enforcing the throttling policy associated with the user root key based on the maximum failure count value and the zero validated time. At 1806, in response to a determination that a hardware register is not available, the processor returns an error value indicating that no hardware registers are available.

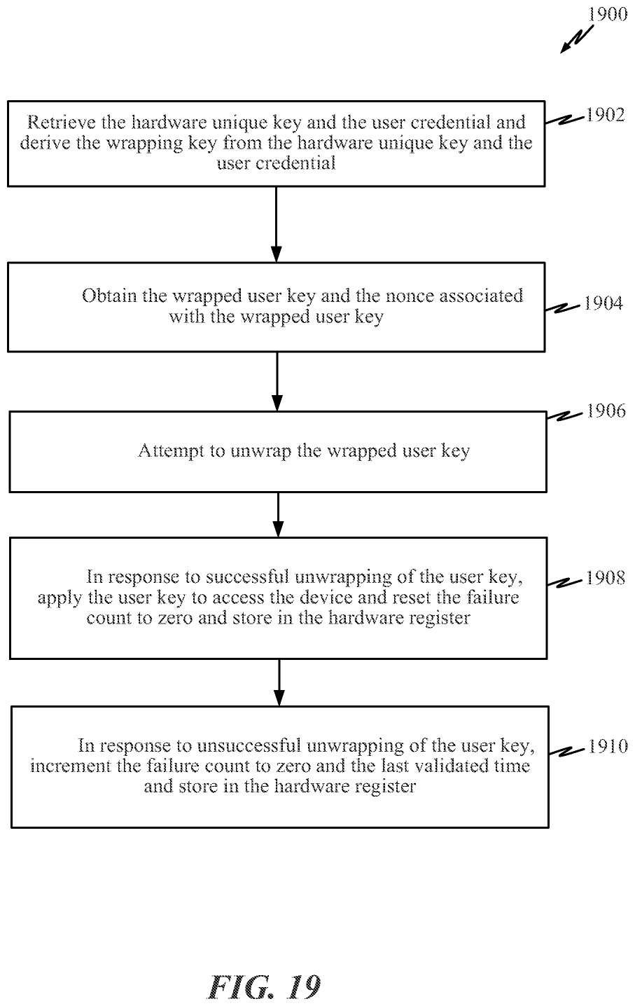

FIG. 19 broadly illustrates and summarizes other exemplary methods or procedures 1800 that may be performed by suitably equipped devices or components, such as the processors of FIGS. 10 and 11, to unwrap a wrapped key for use, for example, along with the method FIG. 16. Briefly, at 1902, the processor retrieves the hardware unique key and the user credential and derives the wrapping key from the hardware unique key and the user credential. At 1904, the processor obtains the wrapped user key and the nonce associated with the wrapped user key. At 1906, the processor attempts to unwrap the wrapped user key. At 1908, in response to successful unwrapping of the user key, the processor applies the user key to access the component and resets the failure count to zero and stores the values in the hardware register. At 1910, in response to unsuccessful unwrapping of the user key, the processor increments the failure count to zero and the last validated time and stores the values in the hardware register.

In some aspects, the functions described herein may be performed by any suitable means for performing the functions. For example, an apparatus may include one or more of: means (such as storage controller 1002 of FIG. 10) for storing a cryptographic key that is bound to an access credential; means (such as component 1003 of FIG. 10) for obtaining an access request including an input credential; means (such as component 1004 of FIG. 10) for determining whether there is a credential reentry throttling policy bound to the cryptographic key; means (such as component 1006 of FIG. 10) for enforcing the credential reentry throttling policy for reentry of the input credential in response to a determination that the input credential is invalid and there is a credential reentry throttling policy bound to the cryptographic key; and means (such as component 1008 of FIG. 10) for enabling non-throttled reentry of the access credential in response to a determination that the input credential is invalid but there is no credential reentry throttling policy bound to the cryptographic key. (Herein, “obtaining” broadly covers, e.g., generating, acquiring, receiving, retrieving, or performing any other suitable corresponding actions.)

Note that the aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that, generally speaking, logical blocks, modules, circuits, and algorithm steps may be implemented as electronic hardware, computer software, or combinations of both. To clearly illustrate this interchangeability of hardware and software, which may be appropriate in some cases depending upon the particular function, various illustrative components, blocks, modules, circuits, and steps have been described above generally in terms of their functionality. Whether such functionality is implemented as hardware or software depends upon the particular application and design constraints imposed on the overall system. In particular, as already explained, certain components should be implemented entirely in hardware to provide for effective software resiliency.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The various features described herein can be implemented in different systems. The foregoing embodiments are merely examples and are not to be construed as limiting. The description of the embodiments is intended to be illustrative, and not to limit the scope of the claims.

What is claimed is:

1. A method operational in a processor for processing an access request, the method comprising:
storing a cryptographic key that is bound to an access credential;
obtaining an access request including an input credential;
determining whether there is a credential reentry throttling policy bound to the cryptographic key;
enforcing the credential reentry throttling policy for reentry of the input credential in response to a determination that the input credential is invalid and there is a credential reentry throttling policy bound to the cryptographic key; and
enabling non-throttled reentry of the access credential in response to a determination that the input credential is invalid but there is no credential reentry throttling policy bound to the cryptographic key.

2. The method of claim 1, wherein the access credential is a user credential and the method further comprises:
obtaining a wrapping key from a hardware unique key and binding the wrapping key to the user credential;
obtaining a user root key and binding the user root key to a particular credential reentry throttling policy; and
obtaining an encryption key and binding the encryption key to the user root key.

3. The method of claim 2, further comprising:
deriving a candidate wrapping key from the hardware unique key and the user credential;
attempting to unwrap the encryption key using the candidate wrapping key;
identifying the user credential as a valid credential in response to successful unwrapping of the encryption key;
identifying the user credential as an invalid credential in response to unsuccessful unwrapping of the encryption key; and
enforcing the credential reentry throttling policy that is bound to the user root key in response to unsuccessful unwrapping of the encryption key.

4. The method of claim 2, including an enrollment procedure comprising:
setting a failure count and a last validated time to respective default values;
obtaining the hardware unique key associated with the processor;
deriving the wrapping key from the hardware unique key and the user credential;
obtaining the user root key and wrapping the user root key with a nonce using the wrapping key to obtain a wrapped user root key; and
storing the nonce, the failure count, and the last validated time in a hardware register associated with the user root key.

5. The method of claim 4, including a verification procedure comprising:
obtaining a wrapped user key corresponding to the user credential;
obtaining a first nonce corresponding to the wrapped user key;
obtaining a second nonce from the hardware register associated with the user root key; and
comparing the first and second nonces to determine whether the first nonce and the second nonce are the same.

6. The method of claim 5, wherein, in response to a determination that the first nonce and the second nonce are the same:
determining whether throttling is to be performed based on whether the input credential is invalid;
throttling user access, in response to a determination that throttling is to be performed, by enforcing the credential reentry throttling policy associated with the user root key based on current values of the failure count and the last validated time in the hardware register associated with the user root key; and
unwrapping the user root key without enforcing any credential reentry throttling policy, in response to a determination that throttling is not to be performed.

7. The method of claim 6, wherein, in response to a determination that the first nonce and the second nonce are not the same:
determining whether a hardware register is available for storing a new failure count value and a new last validated time value;
setting the failure count for an available register to a maximum value and setting the last validated time to zero for the hardware register in response to a determination that a hardware register is available, and throttling user access by enforcing the throttling policy associated with the user root key based on the maximum value and the last validated time; and
returning an error value indicating that no suitable hardware registers are available in response to a determination that a hardware register is not available.

8. The method of claim 5, including a user key unwrapping procedure comprising:
retrieving the hardware unique key and the user credential from memory;
deriving the wrapping key from the hardware unique key and the user credential;
obtaining the wrapped user key and the nonce associated with the wrapped user key and attempting to unwrap the wrapped user key to obtain a user key;
applying the user key to access a component of a device, resetting the failure count to zero, and storing the failure count in the hardware register, in response to successful unwrapping of the wrapped user key; and
incrementing the failure count, updating the last validated time, and storing the failure count and the last validated time in the hardware register, in response to unsuccessful unwrapping of the wrapped user key.

9. The method of claim 1, wherein the processor includes a key manager configured in hardware without access to secure storage, and wherein the method further comprises using the key manager to bind a user root key to a hardware register storing parameters for a throttling policy associated with the user root key.

10. The method of claim 9, wherein the user root key is bound to the hardware register by generating a nonce and associating the nonce with both the user root key and the hardware register.

11. The method of claim 1, wherein the throttling policy is a timer-based throttling policy.

12. A device for processing an access request, comprising:
a storage element; and
a processor configured to
store a cryptographic key in the storage element, the cryptographic key bound to an access credential;
obtain an access request including an input credential;
determine whether there is a credential reentry throttling policy bound to the cryptographic key;
enforce the credential reentry throttling policy for reentry of the input credential in response to a determination that the input credential is invalid and there is a credential reentry throttling policy bound to the cryptographic key; and
enable non-throttled reentry of the access credential in response to a determination that the input credential is invalid but there is no credential reentry throttling policy bound to the cryptographic key.

13. The device of claim 12, wherein the access credential is a user credential and the processor is further configured to:
obtain a wrapping key from a hardware unique key and binding the wrapping key to the user credential;
obtain a user root key and binding the user root key to a particular credential reentry throttling policy; and
obtain an encryption key and binding the encryption key to the user root key.

14. The device of claim 13, wherein the processor is further configured to:
derive a candidate wrapping key from the hardware unique key and the user credential;
attempt to unwrap the encryption key using the candidate wrapping key;
identify the user credential as a valid credential in response to successful unwrapping of the encryption key;
identifying the user credential as an invalid credential in response to unsuccessful unwrapping of the encryption key; and
enforce the credential reentry throttling policy that is bound to the user root key in response to unsuccessful unwrapping of the encryption key.

15. The device of claim 13, wherein the processor is further configured to:
set a failure count and a last validated time to default values;
obtain the hardware unique key associated with the processor;
derive the wrapping key from the hardware unique key and the user credential;
obtain the user root key and wrapping the user root key with a nonce using the wrapping key to obtain a wrapped user root key; and
store the nonce, the failure count, and the last validated time in a hardware register associated with the user root key.

16. The device of claim 15, wherein the processor is further configured to:
input a candidate user credential;
obtain a wrapped user key corresponding to the candidate user credential;
obtain a first nonce corresponding to the wrapped user key;
obtain a second nonce from the hardware register associated with the user root key; and
compare the first and second nonces to determine whether the first nonce and the second nonce are the same.

17. The device of claim 16, wherein the processor is further configured to:
determine, in response to a determination that the first nonce and the second nonce are the same, whether throttling is to be performed;
throttle user access, in response to a determination that throttling is to be performed, by enforcing the throttling policy associated with the user root key based on current values of the failure count and the last validated time in the hardware register associated with the user root key; and
unwrap the user root key without enforcing any throttling policy, in response to a determination that throttling is not to be performed.

18. The device of claim 17, wherein the processor is further configured to:
determine, in response to a determination that the first nonce and the second nonce are not the same, whether a hardware register is available for storage of a new failure count value and a new last validated time value;
set the failure count for the available register to a maximum value, set the last validated time to zero for the hardware register, and throttle the user access by enforcing the throttling policy associated with the user root key based on a maximum value and the validated time, in response to a determination that a hardware register is available; and
return an error value indicating that no suitable hardware registers are available, in response to a determination that a hardware register is not available.

19. The device of claim 16, wherein the processor is further configured to:
retrieve the hardware unique key and the user credential;
derive the wrapping key from the hardware unique key and the user credential;
obtain the wrapped user key and the nonce associated with the wrapped user key and attempting to unwrap the wrapped user key to obtain a user key;
apply the user key to access a component of a device, reset the failure count to zero, and store the failure count in the hardware register, in response to successful unwrapping of the user key; and
increment the failure count, reset the last validated time, and store the failure count and the last validated time in the hardware register, in response to unsuccessful unwrapping of the user key.

20. The device of claim 12, wherein the processor includes a key manager configured in hardware without access to secure storage, and wherein the key manager is configured to bind a user root key to a hardware register that stores parameters for a throttling policy associated with the user root key.

21. The device of claim 12, wherein the processor is a component of a mobile device and the input credential is a user password to unlock the mobile device.

22. An apparatus for processing an access request, comprising:
means for storing a cryptographic key that is bound to an access credential;
means for obtaining an access request including an input credential;
means for determining whether there is a credential reentry throttling policy bound to the cryptographic key;
means for enforcing the credential reentry throttling policy for reentry of the input credential in response to a determination that the input credential is invalid and there is a credential reentry throttling policy bound to the cryptographic key; and
means for enabling non-throttled reentry of the access credential in response to a determination that the input credential is invalid but there is no credential reentry throttling policy bound to the cryptographic key.

23. The apparatus of claim 22, further comprising:
means for obtaining a wrapping key from a hardware unique key and binding the wrapping key to a user credential;
means for obtaining a user root key and binding the user root key to a particular credential reentry throttling policy; and
means for obtaining an encryption key and binding the encryption key to the user root key.

24. The apparatus of claim 23, further comprising:
means for deriving a candidate wrapping key from the hardware unique key and a user credential;
means for attempting to unwrap the encryption key using the candidate wrapping key;
means for identifying the user credential as a valid credential in response to successful unwrapping of the encryption key; and
means for enforcing the credential reentry throttling policy that is bound to the user root key in response to unsuccessful unwrapping of the encryption key.

25. The apparatus of claim 23, further comprising:
means for setting a failure count and a last validated time to default values;
means for obtaining the hardware unique key associated with the processor;
means for deriving the wrapping key from the hardware unique key and the user credential;
means for obtaining the user root key and wrapping the user root key with a nonce using the wrapping key to obtain a wrapped user root key; and
means for storing the nonce, the failure count, and the last validated time in a hardware register associated with the user root key.

26. The apparatus of claim 25, further comprising:
means for inputting a candidate user credential;
means for obtaining a wrapped user key corresponding to the candidate user credential;
means for obtaining a first nonce corresponding to the wrapped user key;
means for obtaining a second nonce from the hardware register associated with the user root key; and
means for comparing the first and second nonces to determine whether the first nonce and the second nonce are the same.

27. The apparatus of claim 26, further comprising:
means for determining whether throttling is to be performed;
means for throttling user access, in response to a determination that throttling is to be performed, by enforcing the throttling policy associated with the user root key based on current values of the failure count and the last validated time in the hardware register associated with the user root key; and
means for unwrapping the wrapped user key without enforcing any throttling policy, in response to a determination that throttling is not to be performed.

28. The apparatus of claim 27, further comprising:
means for determining whether a hardware registers is available for storage of a new failure count value and a new last validated time value;
means for setting the failure count for the available register to a maximum value and setting the last validated time to zero for the hardware register in response to a determination that a hardware register is available, and throttling user access by enforcing the throttling policy associated with the user root key based on the maximum value and the zero validated time; and
means for returning an error value indicating that no suitable hardware registers are available in response to a determination that a hardware register is not available.

29. The apparatus of claim 22, wherein the means for enforcing a throttling policy comprises a means for enforcing a timer-based throttling policy.

30. A processor-readable storage medium having one or more instructions for processing an access request which when executed by at least one processing circuit causes the at least one processing circuit to:
store a cryptographic key that is bound to an access credential;
obtain an access request including an input credential;
determine whether there is a credential reentry throttling policy bound to the cryptographic key;
enforce the credential reentry throttling policy for reentry of the access credential in response to a determination that the input credential is invalid and there is a credential reentry throttling policy bound to the cryptographic key; and
enable non-throttled reentry of the access credential in response to a determination that the input credential is invalid but there is no credential reentry throttling policy bound to the cryptographic key.
